(19) United States
(12) Patent Application Publication
(10) Pub. No.: US 2026/0225821 A1
(43) Pub. Date: Aug. 6, 2026

(54) AUGER CONVEYOR SYSTEM FOR MILLING MACHINE

(71) Applicant: Caterpillar Paving Products Inc., Brooklyn Park, MN (US)

(72) Inventors: Daniel HEIM, Blaine, MN (US); Matthew James FRITZKE, Watertown, MN (US); Eric S. ENGELMANN, Delano, MN (US)

(73) Assignee: Caterpillar Paving Products Inc., Brooklyn Park, MN (US)

(21) Appl. No.: 19/044,496

(22) Filed: Feb. 3, 2025

(51) Int. Cl. B65G 33/26; B65G 33/14; B65G 33/34; E01C 19/48

(52) U.S. Cl. CPC B65G 33/265; B65G 33/14; B65G 33/34; E01C 19/48; B65G 2201/045

(57) ABSTRACT

A primary conveyor of a cold planer may include a housing and an auger at least partially disposed within the housing and configured to rotate. The auger may include a shaft and spiral flighting disposed on the shaft. The spiral flighting may have a pitch configured to move debris to a secondary conveyor during rotation of the auger. The primary conveyor may further include a motor configured to rotate the shaft of the auger.

### TECHNICAL FIELD

The present disclosure relates generally to a milling machine and, for example, to a cold planer having a milled material removal system.

### BACKGROUND

Various construction machines include a conveyor system. For example, a cold planer is a construction machine that mechanically mills and removes material (e.g., asphalt or concrete) from a surface. The cold planer includes a rotating drum equipped with cutting tools that engage the surface to produce milled material. The cold planer may further include mechanisms for controlling the depth and width of material removal, as well as a conveyor system to transport the milled material away from the machine. Another construction machine that includes a conveyor system to move materials is a paving machine, such as an asphalt paver. The paving machine may use the conveyor system to move asphalt from a hopper to a screed assembly so that the asphalt can be compacted on a paving surface.

Conveyor systems used with construction machines may include a conveyor belt attached to rollers driven by one or more motors. Conveyor systems are subject to normal wear-and-tear, and over time, the conveyor belt, rollers, and/or motors may need to be serviced or replaced. Servicing or replacing parts of the conveyor system often requires disassembling sections of the construction machine, which can take a significant amount of time and effort, leading to substantial downtime at a construction site.

U.S. Pat. No. 11,273,752 (the '752 patent) discloses that, when a milling drum is rotated and a cold planer travels forward, cutting tools impact, breakup and dislodge pavement at a worksite. To remove the broken up material, a conveyor is partly disposed internally through the cold planer from proximate the milling drum to a location where the material can be discharged to the haul bed of a haul truck. With respect to a paver, the '752 patent discloses, to convey material between a hopper and a screed, an internal continuous conveyor may be disposed through the paver longitudinally between the front and the rear. The conveyor can include a belt that continuously travels in a closed loop through the paver. In an embodiment, an auger may be utilized instead of or in addition to the conveyor. While the '752 patent discloses some benefits, the milled material removal system and/or primary conveyor of the present disclosure is associated with other benefits.

### SUMMARY

A primary conveyor of a cold planer may include a housing; an auger at least partially disposed within the housing and configured to rotate, wherein the auger includes a shaft and spiral flighting disposed on the shaft, wherein the spiral flighting has a pitch configured to move debris to a secondary conveyor during rotation of the auger; and a motor configured to rotate the shaft of the auger.

A milled material removal system for a cold planer may include a milling drum; a primary conveyor having: a first housing having a first end proximate the milling drum and a second end opposite the first end, a first auger disposed within the first housing, and a first motor configured to rotate the first auger; and a secondary conveyor having a charge end adjacent to the second end of the first housing of the primary conveyor and a discharge end opposite the charge end, wherein the primary conveyor is configured to move a milled material away from the milling drum and toward the secondary conveyor, and wherein the secondary conveyor is configured to move the milled material away from the second end of the primary conveyor and toward the discharge end of the secondary conveyor.

A method may include aligning an opening of a housing of a first primary conveyor to an opening of a pivot arm of an anti-slab device of a cold planer; and inserting a hinge rod through the opening in the pivot arm of the anti-slab device and through the opening of the housing of the first primary conveyor, wherein the hinge rod rotatably attaches the first primary conveyor to the pivot arm of the anti-slab device.

### BRIEF DESCRIPTION OF THE DRAWINGS

FIG. 1 is a side view of an example cold planer for removing milled material from a worksite.

FIGS. 2 and 3 illustrate an example side view and front view, respectively, of a primary conveyor attached to a milling drum.

FIG. 4 is an example front view of an auger and housing.

FIG. 5 illustrates an example side view of a secondary conveyor having an auger.

FIG. 6 illustrates an example side view of the secondary conveyor having a chute.

FIG. 7 illustrates an example top view of the primary conveyor or the secondary conveyor having multiple augers.

FIG. 8 illustrates an example flowchart associated with the primary conveyor of the cold planer.

### DETAILED DESCRIPTION

This disclosure relates to a milled material removal system, which is applicable to any machine that removes milled material from a worksite via a primary conveyor, a secondary conveyor, and/or a combination thereof, among other examples. For example, the machine may be a milling machine or a cold planer.

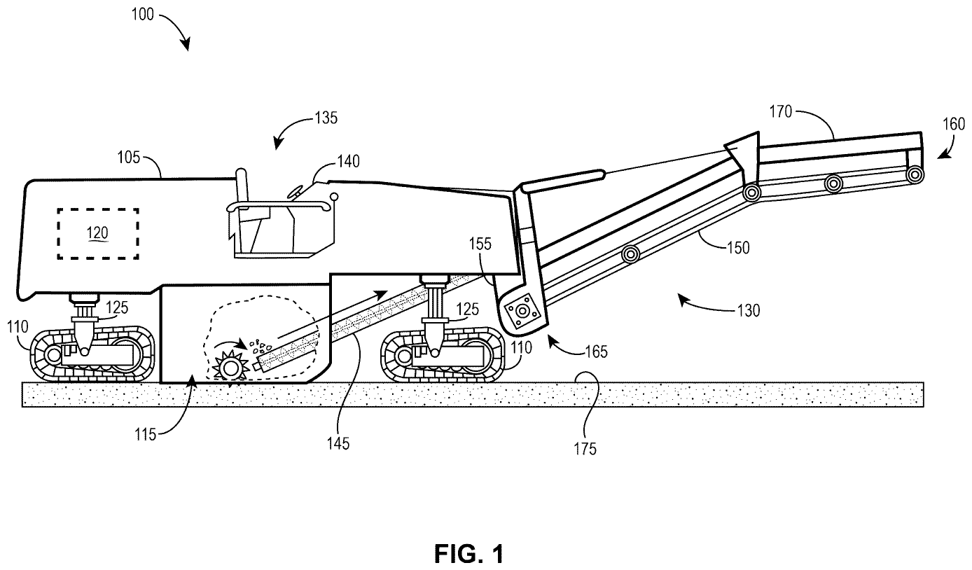

FIG. 1 is a side view of an example cold planer 100 for removing milled material from a worksite. The cold planer 100 may include a frame 105 supported by one or more traction devices 110, a milling drum 115 rotationally supported under a belly of the frame 105, and an engine 120 mounted to the frame 105 and configured to drive the traction devices 110 and the milling drum 115. The traction devices 110 may include either wheels or tracks connected to actuators 125 that are adapted to controllably raise and lower the frame 105 relative to a ground surface. Raising and lowering of the frame 105 may function to vary a milling depth of the milling drum 115 into a work surface 175. The same or different actuators 125 may be used to steer the cold planer 100 and/or to adjust a travel speed of the traction devices 110 (e.g., to speed up or brake the traction devices 110). A conveyor system 130 may be connected at a leading end to the frame 105 and configured to transport material away from the milling drum 115 and into a receptacle, such as a waiting haul vehicle.

The frame 105 may support an operator station 135. The operator station 135 may be located at a side of the cold planer 100 opposite milling drum 115. The operator station 135 may house a control console 140 with any number of interface devices used to control the cold planer 100.

The conveyor system 130 may include a primary conveyor 145 adjacent the milling drum 115. The primary conveyor 145 may be configured to receive the milled material from the milling drum 115 at a charge end of the primary conveyor 145, and to provide, at a discharge end of primary conveyor 145, the milled material to a secondary conveyor 150. The secondary conveyor 150 may receive the milled material via a flexible hopper 155 of the secondary conveyor 150, positioned below the primary conveyor 145, and may dispense the milled material into the haul vehicle at an elevated discharge end 160 of the secondary conveyor 150. The flexible hopper 155 may be connected to (e.g., fixed to, attached to, fastened to, formed as a part of, adhered to, or the like) the secondary conveyor 150 at a charge end 165 of the secondary conveyor 150. The flexible hopper 155 may include one or more flexible supports, a skirt, a hopper weldment, or the like to receive the milled material and may be able to expand or contract as necessary for the amount of material being transferred and/or expand or contract as necessary according to the configuration of the primary conveyor 145 relative to the secondary conveyor 150. The charge end 165 may be configured in a position below a discharge end of the primary conveyor 145, such that material transferred from the discharge end of the primary conveyor falls into the flexible hopper 155 and the charge end 165 of the secondary conveyer.

The secondary conveyor 150 may be rotatably attached to the frame 105 at the charge end 165 so that the secondary conveyor 150 can vertically rotate and a height at which milled material leaves the secondary conveyor 150 at the discharge end 160 may be adjusted. Additionally or alternatively, the secondary conveyor 150 may be rotatably attached to the frame 105 at the charge end 165 so that second conveyor can horizontally rotate so that a direction at which the milled material leaves the secondary conveyor 150 may be adjusted relative to a direction of travel of the cold planer 100 or the primary conveyor 145.

As shown in FIG. 1, the primary conveyor 145 may include an auger configured to move the milled material from the milling drum 115 to the secondary conveyor 150. The secondary conveyor 150 may include a belt that is supported by one or more roller assemblies and driven by a motor. The motor may include, for example, a hydraulic motor, an electric motor, or the like. Alternatively, as discussed in greater detail below, the secondary conveyor 150 may include an auger to move the milled material to the haul truck. The secondary conveyor 150 may include a cover 170 to prevent debris from falling and/or accumulating on belt or other components of second conveyor.

As indicated above, FIG. 1 is provided as an example. Other examples may differ from what is described with regard to FIG. 1.

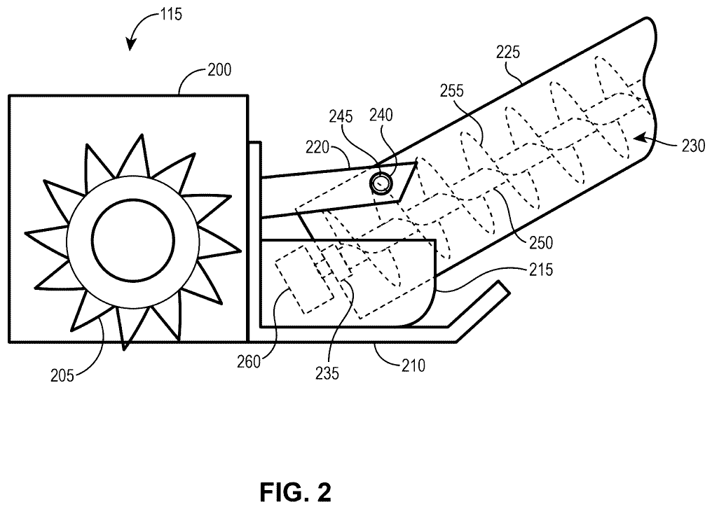

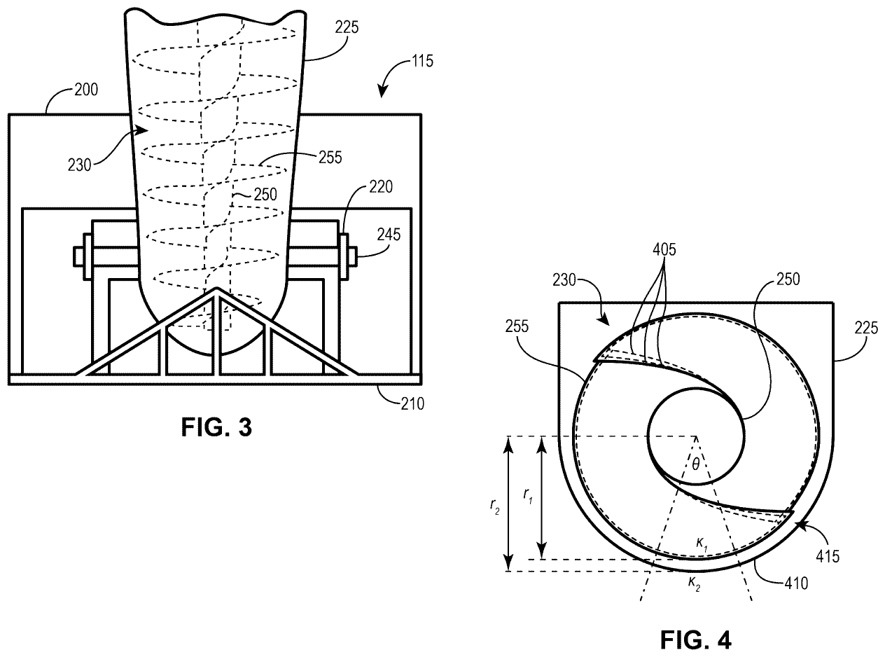

FIGS. 2 and 3 illustrate an example side view and front view, respectively, of the primary conveyor 145 attached to a milling drum 115. As shown in FIGS. 2-3, the milling drum 115 may include a cutting chamber 200 partially enclosing a cutting tool 205, an anti-slab device 210 disposed on the cutting chamber 200, a primary hopper 215 disposed on the anti-slab device 210, and a pivot arm 220 disposed on the anti-slab device 210. The primary conveyor 145 may include a housing 225, an auger 230, and a support bearing 235.

The cutting tool 205 may be configured to mill the work surface 175 and deposit the milled material in the primary hopper 215. The anti-slab device 210 may be configured to rest on the work surface 175 during a milling operation. The anti-slab device 210 may be configured to move vertically as the cutting tool 205 mills the work surface 175. For example, as the work surface 175 is milled, a top section of the work surface 175 may be broken and deposited into the primary hopper 215, which may cause the anti-slab device 210 to move downward. When the cold planer 100 is moved to a different section of the work surface 175 (e.g., a section of the work surface 175 that has not been milled), the anti-slab device 210 may be moved upward so that the anti-slab device 210 sits atop the work surface 175. As the anti-slab device 210 moves vertically, the housing 225 of the primary conveyor 145 may rotate about a pivot point 240 in the pivot arm 220. For example, in the orientation shown in FIG. 2, the primary conveyor 145 may rotate counter-clockwise about the pivot point 240 as the work surface 175 is milled and rotate clockwise when the cold planer 100 is moved to a different section of the work surface 175 that has not yet been milled. The housing 225 may be connected to the pivot arm 220 via a hinge rod 245 that extends through openings in the pivot arm 220 and the housing 225.

The primary conveyor 145 may include an auger 230. The auger 230 may include a shaft 250 and spiral flighting 255 disposed on the shaft 250. The shaft 250 may be attached to the housing 225 via the support bearing 235. Additionally, the shaft 250 may be rotated by a motor 260. The spiral flighting 255 may have a pitch configured to move debris (e.g., the milled material) from the primary hopper 215 to the secondary conveyor 150. For example, the spiral flighting 255 may include two or more auger segments that are individually attached to the shaft 250, and the auger segments may include curved blades that define the pitch of the spiral flighting 255.

As indicated above, FIGS. 2-3 are provided as examples. Other examples may differ from what is described with regard to FIGS. 2-3.

FIG. 4 is an example front view of the auger 230 and housing 225. The auger 230 and housing 225 shown in FIG. 4 may be incorporated into the primary conveyor 145, the secondary conveyor 150, or both. The auger 230 may include the shaft 250 and spiral flighting 255, as discussed above. The spiral flighting 255 may include two or more auger segments 405 that are individually attached to the shaft 250. At least a section of the auger segments 405 may have a curvature κ₁ that is approximately equal to a curvature κ₂ of at least a portion of the housing 225. For example, as shown in FIG. 4, over a given angle θ from the center of the shaft 250, a distance r₁ of an outer perimeter of the auger segments 405 to the center of the shaft 250, and a distance r₂ of a portion of a bottom surface 410 of the housing 225 to the center of the shaft 250, the curvature κ₂ may be approximately equal (e.g., within 30%) to the curvature κ1. With the same or similar curvatures, a gap 415 between the bottom surface 410 of the housing 225 and the auger segments 405 may be minimized, which may reduce an amount of milled material that cannot be pushed by the auger 230 (e.g., the auger 230 will move milled material larger than the gap 415). As indicated above, FIG. 4 is provided as an example. Other examples may differ from what is described with regard to FIG. 4.

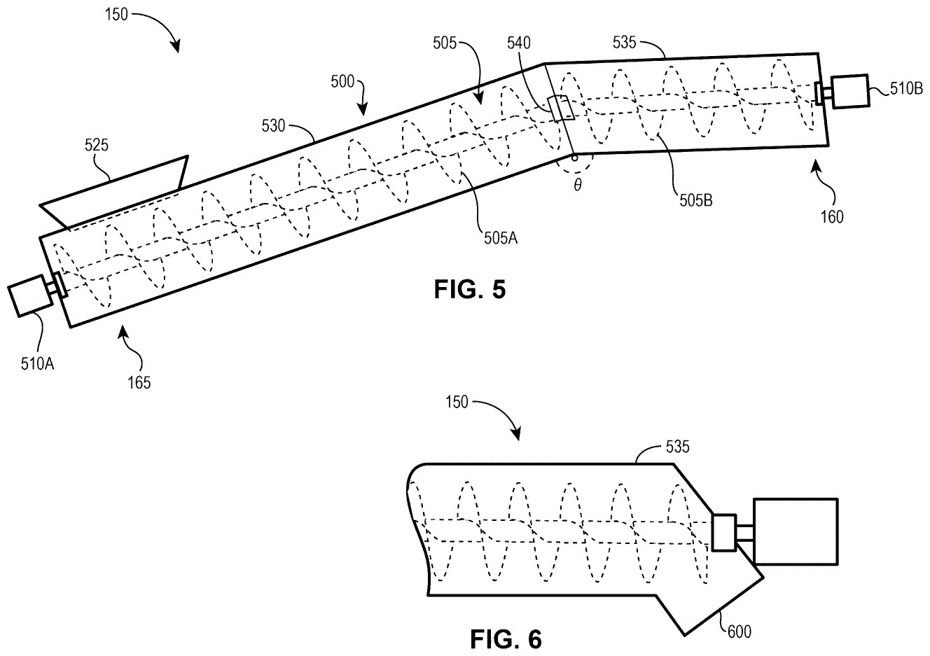

FIG. 5 illustrates an example side view of the secondary conveyor 150 having an auger. As shown in FIG. 5, the secondary conveyor 150 may include a housing 500, an auger 505 disposed within the housing 500, and a motor 510 configured to rotate the auger 505 of the secondary conveyor 150. When included in the cold planer 100, the secondary conveyor 150 may have a charge end 165 adjacent to the second end of the housing 225 of the primary conveyor 145. Additionally, the secondary conveyor 150 may have a discharge end 160 opposite the charge end 165.

The secondary conveyor 150 may include a hopper 525 disposed on the housing 500. The hopper 525, which may be the same as or different from the flexible hopper 155 discussed above with respect to FIG. 1, may be configured to receive the milled material from the primary conveyor 145 and deposit the milled material into the housing 500 of the secondary conveyor 150. The auger 505 of the secondary conveyor 150 may include a shaft 250 and spiral flighting 255. The motor 510 may rotate the shaft 250, which may, in turn, cause the spiral flighting 255 to rotate and move the milled material from the charge end 165 of the housing 500 of the secondary conveyor 150 to the discharge end 160 of the housing 500 of the secondary conveyor 150.

As shown in FIG. 5, the housing 500 of the secondary conveyor 150 may be separated into a first segment 530 and a second segment 535. The second segment 535 may be disposed on or adjacent to the first segment 530. The first segment 530 may be located at the charge end of the secondary conveyor 150, and the second segment 535 may be located at the discharge end of the secondary conveyor 150. Each of the first segment 530 and the second segment 535 includes separate augers and motors (shown as augers 505A and 505B and motors 510A and 510B, respectively) to rotate the augers 505. The first segment 530 and the second segment 535 may be non-colinear relative to one another. For example, the second segment 535 may extend at an angle θ relative to the first segment 530, and the angle θ may be greater than 0 degrees and less than 180 degrees. Additionally, a hinge 540 may be disposed between the first segment 530 and the second segment 535. The hinge 540 may permit the second segment 535 to rotate relative to the first segment 530 to, for example, fold the second segment 535. Folding the second segment 535 may reduce a height and/or width of the cold planer 100, which may make the cold planer 100 easier to transport between work sites.

As indicated above, FIG. 5 is provided as an example. Other examples may differ from what is described with regard to FIG. 5.

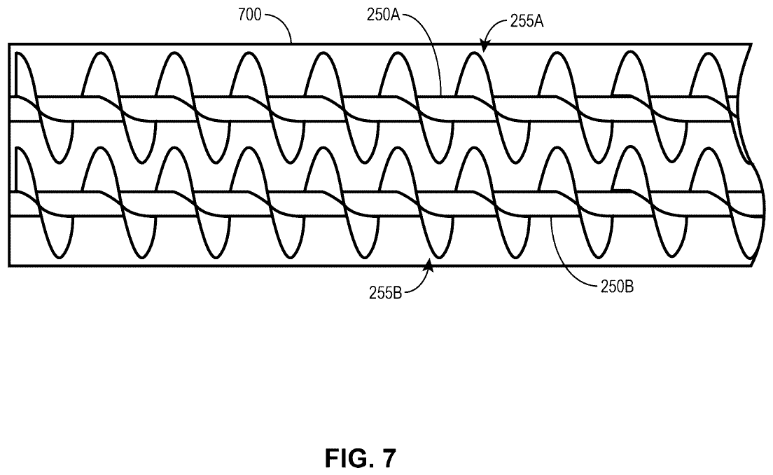

FIG. 6 illustrates an example side view of the secondary conveyor 150 having a chute 600. The chute 600 may be located at the discharge end of the secondary conveyor 150. If the secondary conveyor 150 includes multiple segments (e.g., the first segment 530 and the second segment 535 discussed above with respect to FIG. 5), the chute 600 may be located at the discharge end of the segment furthest from the primary conveyor 145 (e.g., the second segment 535 of FIG. 5). The chute 600 may be angled toward a haul truck, dumpster, or other receptacle for receiving the milled material. As indicated above, FIG. 6 is provided as an example. Other examples may differ from what is described with regard to FIG. 6.

FIG. 7 illustrates an example top view of the primary conveyor 145 or the secondary conveyor 150 having multiple augers. For example, as shown in FIG. 7, rather than having a single auger (e.g., a single shaft 250 with multiple auger segments), the housing 700 for the primary conveyor 145 or the secondary conveyor 150 may include two or more augers adjacent to one another. For example, the housing 700 may include a first shaft 250A with a first spiral flighting 255A and a second shaft 250B with a second spiral flighting 255B. The first shaft 250A and the second shaft 250B may be disposed in the housing 700 parallel to one another. The auger segments of the first spiral flighting 255A and the auger segments of the second spiral flighting 255B may be offset from one another, which may allow the first spiral flighting 255A and the second spiral flighting 255B of different augers to at least partially nest, which can reduce the amount of milled material (as shown in FIG. 1) that falls between the augers. As indicated above, FIG. 7 is provided as an example. Other examples may differ from what is described with regard to FIG. 7.

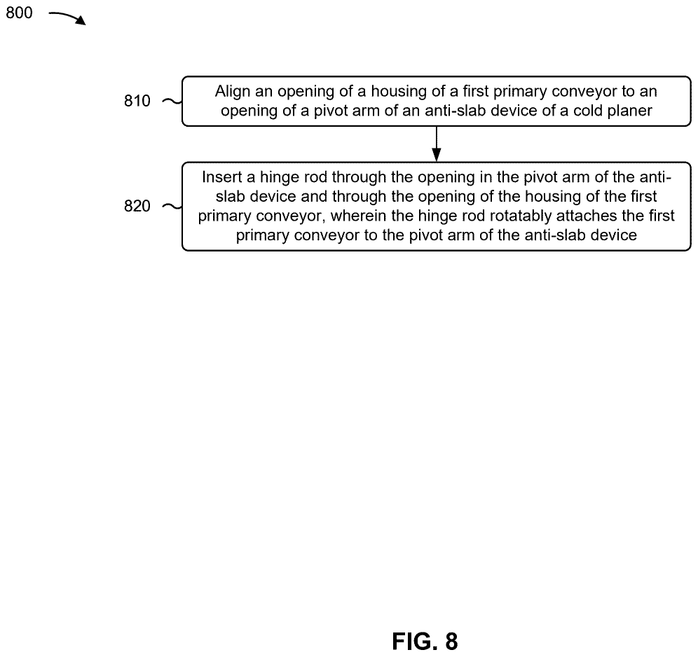

FIG. 8 is a flowchart of an example process 800 associated with the primary conveyor of a cold planer (e.g., cold planer 100). As shown in FIG. 8, process 800 may include aligning an opening of a housing of a first primary conveyor to an opening of a pivot arm of an anti-slab device of a cold planer (block 810), and inserting a hinge rod through the opening in the pivot arm of the anti-slab device and through the opening of the housing of the first primary conveyor (block 820). As discussed above, the hinge rod rotatably attaches the first primary conveyor to the pivot arm of the anti-slab device. The process 800 may further include removing the hinge rod from the housing of the first primary conveyor and the pivot arm of the anti-slab device, separating the first primary conveyor from the anti-slab device, aligning an opening of a housing of a second primary conveyor to the opening of the pivot arm of the anti-slab device, and inserting the hinge rod through the opening in the pivot arm of the anti-slab device and through the opening of the housing of the second primary conveyor. Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

### INDUSTRIAL APPLICABILITY

The cold planer 100, having the primary conveyor 145 and the secondary conveyor 150 discussed above, may be used to remove milled material from a worksite. As discussed above, the conveyor system 130 (e.g., the primary conveyor 145 and/or the secondary conveyor 150) may incorporate augers (e.g., the auger 230 and/or the auger 505) rather than conveyor belts and pulleys. When the conveyor belts and pulleys are replaced with augers, servicing the conveyor system 130 may become faster, which can reduce downtime and construction delays. For example, when the conveyor system 130 uses augers, the primary conveyor 145 may be removed and serviced by removing the hinge rod 245 that extends through the pivot arm 220 and the housing 225 of the primary conveyor 145. Accordingly, the primary conveyor 145 may be serviced and replaced without disassembling a conveyor belt and rollers.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A primary conveyor of a cold planer, comprising:
a housing;
an auger at least partially disposed within the housing and configured to rotate,
wherein the auger includes a shaft and spiral flighting disposed on the shaft,
wherein the spiral flighting has a pitch configured to move debris to a secondary conveyor during rotation of the auger; and
a motor configured to rotate the shaft of the auger.

2. The primary conveyor of claim 1, wherein the housing is configured to attach to an anti-slab device.

3. The primary conveyor of claim 1, wherein the housing defines one or more openings for receiving a hinge rod, and wherein the housing is configured to rotate about the hinge rod.

4. The primary conveyor of claim 1, wherein the spiral flighting includes two or more auger segments individually attached to the shaft.

5. The primary conveyor of claim 1, wherein the housing has a rounded bottom surface.

6. The primary conveyor of claim 1, wherein at least portion of a bottom surface of the housing and at least a portion of an outer perimeter of the spiral flighting have a same curvature.

7. A milled material removal system for a cold planer, comprising:
a milling drum;
a primary conveyor having:
a first housing having a first end proximate the milling drum and a second end opposite the first end,
a first auger disposed within the first housing, and
a first motor configured to rotate the first auger; and
a secondary conveyor having a charge end adjacent to the second end of the first housing of the primary conveyor and a discharge end opposite the charge end,
wherein the primary conveyor is configured to move a milled material away from the milling drum and toward the secondary conveyor, and
wherein the secondary conveyor is configured to move the milled material away from the second end of the primary conveyor and toward the discharge end of the secondary conveyor.

8. The milled material removal system of claim 7, wherein the secondary conveyor includes:
a second housing;
a second auger disposed within the second housing; and
a second motor configured to rotate the second auger.

9. The milled material removal system of claim 8, wherein the second housing includes a first segment and a second segment disposed on or adjacent to the first segment, and wherein the second segment is non-colinear relative to the first segment.

10. The milled material removal system of claim 8, wherein the secondary conveyor includes a hinge operatively connected to a first segment of the second housing and a second segment of the second housing.

11. The milled material removal system of claim 8, wherein the second auger is disposed in a first segment of the second housing,
wherein the secondary conveyor includes a third auger disposed on a third shaft in a second segment, and
wherein the secondary conveyor further includes a third motor configured to rotate the third shaft.

12. The milled material removal system of claim 7, wherein the secondary conveyor includes:
one or more rollers;
a conveyor belt disposed on the one or more rollers; and
a second motor configured to rotate the one or more rollers.

13. The milled material removal system of claim 7, wherein the primary conveyor extends at a first angle relative to a ground surface and the secondary conveyor extends at a second angle relative to the ground surface, and wherein the first angle is different from the second angle.

14. The milled material removal system of claim 7, further comprising an anti-slab device, wherein the first housing of the primary conveyor is rotatably attached to the anti-slab device via a hinge rod.

15. The milled material removal system of claim 7, further comprising an anti-slab device, wherein the first housing is removably attached to the anti-slab device.

16. The milled material removal system of claim 7, further comprising a first hopper disposed on or adjacent to the first housing and configured to receive the milled material from the milling drum.

17. The milled material removal system of claim 16, further comprising a second hopper disposed on or adjacent to the secondary conveyor and configured to receive the milled material from the primary conveyor.

18. The milled material removal system of claim 7, wherein the discharge end of the secondary conveyor includes a chute configured to eject the milled material.

19. A method, comprising:
aligning an opening of a housing of a first primary conveyor to an opening of a pivot arm of an anti-slab device of a cold planer; and
inserting a hinge rod through the opening in the pivot arm of the anti-slab device and through the opening of the housing of the first primary conveyor,
wherein the hinge rod rotatably attaches the first primary conveyor to the pivot arm of the anti-slab device.

20. The method of claim 19, further comprising:
removing the hinge rod from the housing of the first primary conveyor and the pivot arm of the anti-slab device;
separating the first primary conveyor from the anti-slab device;
aligning an opening of a housing of a second primary conveyor to the opening of the pivot arm of the anti-slab device; and
inserting the hinge rod through the opening in the pivot arm of the anti-slab device and through the opening of the housing of the second primary conveyor.
